(19) United States
(12) Patent Application Publication
(10) Pub. No.: US 2021/0289608 A1
(43) Pub. Date: Sep. 16, 2021

(54) ILLUMINATION CONTROL

(71) Applicant: PHILIPS LIGHTING HOLDING B.V., EINDHOVEN (NL)

(72) Inventors: DZMITRY VIKTOROVICH ALIAKSEYEU, EINDHOVEN (NL); JONATHAN DAVID MASON, WAALRE (NL)

(21) Appl. No.: 16/317,899

(22) PCT Filed: Jul. 6, 2017
(86) PCT No.: PCT/EP2017/066985

§ 371 Date: Jan. 15, 2019

(30) Foreign Application Priority Data
Jul. 15, 2016 (EP) 16179701.4

(51) Int. Cl. H05B 47/19; H05B 47/115; H05B 47/155

(52) U.S. Cl. CPC H05B 47/19; H05B 47/155; H05B 47/115

(57) ABSTRACT

A lighting control method and apparatus for controlling illumination of a space in which pressure of a user input to an input device can be detected, and is used to control a system of one or more lighting devices. The input may be to a touchscreen of a mobile device such as a smartphone or tablet having a pressure sensing screen. The detected pressure controls the extent to which a lighting effect is applied. A lighting effect may be uniform, such as a constant brightness or a particular color, or it can be a more complex effect involving a mix of parameters of color and brightness across different luminaries. The extent may refer to the number of luminaires to which the effect is applied, or to the physical distance over which the effect is applied.

### TECHNICAL FIELD

The present disclosure relates to illumination control, and particularly but not exclusively to control of one or more lighting devices with a user interface device.

### BACKGROUND

“Connected lighting” refers to a system of luminaires which are controlled not by (or not only by) a traditional wired, electrical on-off or dimmer circuit, but rather via a wired or more often wireless network using a digital communication protocol. Typically, each of a plurality of luminaires, or even individual lamps within a luminaire, may each be equipped with a wireless receiver or transceiver for receiving lighting control commands from a lighting control device according to a wireless networking protocol such as ZigBee, Wi-Fi or Bluetooth (and optionally also for sending status reports to the lighting control device using the wireless networking protocol).

Luminaires may have individually controllable parameters, such as brightness and color, and one or more luminaires may be controlled together in a group in a coordinated manner to create an overall light distribution, or scene, for illuminating an area or space such as a room in a desired manner. Combinations of different luminaires and/or different settings of the luminaires can achieve a different overall illumination or lighting effect of the area of space, as desired. Rather than having to control individual luminaires, or even individual settings for the or each luminaire, in order to achieve a desired effect, it is usually preferable for groups of settings to be stored together corresponding to a desired lighting distribution, or scene. For example a “morning” scene, or a “relaxing” scene can be created. Such a scene can be further controlled by adjusting parameters of luminaires, or adjusting the number of luminaires included, thus giving a tailored illumination effect. It will therefore be understood that a large number of lighting options quickly become available.

U.S. patent application (2012/0169616 A1) relates to a method for operating a lighting control console for controlling a lighting system, wherein digital adjusting commands are transferred to the lighting devices of the lighting system. The lighting control console comprises a display device for depicting graphical elements to the user. The display device exhibits a touch-sensitive sensor surface. The method comprises detecting the touching of the touch-sensitive sensor surface and measuring the dimension of the contact surface, and generating an adjusting command for controlling the lighting system as a function of the measured dimension of the contact surface. A parameter of a lighting device, for instance the lighting intensity of a spotlight, could then be set corresponding to this measurement.

### SUMMARY

In order to be able to control a large number of variables, it is desirable to provide an effective and intuitive control method and/or interface for a user.

Lighting systems can be controlled via the use of a smart device, such as a smartphone or tablet running software or an application or “app”. User commands are typically input via a touchscreen interface. A recent advancement in touchscreen technology has been the introduction of sensors and sensing of the pressure applied to the screen by a user. By way of background, reference is directed to http://www.xda-developers.com/how-and-why-force-touch-can-revolutionize-smartphone-interfaces-2/.

WO 2011/007291 discloses a method of generating a playlist of media objects or modalities based on a user input, and states that a pressure of a user input can be detected.

It would be desirable to use sensed pressure to provide improved illumination control.

According to a first aspect of the present invention, there is provided a lighting control method for controlling illumination of a space by one or more lighting devices with a user terminal, the method comprising detecting a touch input to said user terminal, and associating a desired lighting effect with said touch input; detecting the pressure of said touch input, and determining an extent of said desired lighting effect based on said detected pressure; and controlling said one or more lighting devices based on said desired lighting effect and the determined extent of said effect.

In this way, a simple and intuitive user input variable can be used to control multiple lighting parameters simultaneously using only a single touch or point of contact. By using pressure as an input variable, other input parameters such as position of a touch on a screen or display, or movement such as swiping can be used for other control functions, which may optionally be used simultaneously.

In embodiments, changes in pressure are detected, and the extent of said lighting effect is changed accordingly. Thus the extent can be increased or decreased by increasing or decreasing pressure. It is particularly advantageous to be able to provide bidirectional control with a single point of contact input, as illustrated by considering an input which detects the duration of a touch input, which cannot easily be reduced.

The determined extent is a measure of distance of a desired lighting effect from a point of origin in said space in some embodiments. Thus where an effect has a given illumination over a space or area, the effect can be controlled to be applied selectively over that area, starting at a point of origin, and extending or spreading through the space or area. Lighting parameters representing the effect can be applied in a corresponding selective, gradual manner, in response to detected pressure of the input. The point of origin may be determined in advance, for example by a separate input or as a default value, or may be determined based on the detected touch input.

In some embodiments the determined extent is the number of lighting devices controlled to produce a desired effect. Thus increasing or decreasing pressure can result in an increased or decreased number of luminaries used to produce or contribute to the effect.

In embodiments the desired lighting effect is defined by a set of predetermined values for at least one lighting parameter for said one or more lighting devices. Possible lighting parameters include brightness, intensity, color, saturation, color temperature, or a parameter defining a dynamic effect for example.

It will therefore be understood that in examples, where a parameter is attributed or assigned to a lighting device or luminaire as part of an effect, the degree to which that parameter is output by that device can be controlled according to the determined extent. Thus the extent may be defined by a weighting factor or factors for one or more luminaires, based on the detected pressure, which is applied to lighting parameters of the desired lighting effect. Where a particular luminaire is an area, or provides illumination of an area, which is to be controlled to a lesser or lower extent, the weighting factor may be a fraction or zero for example. The weighting factor may be increased as the extent is increased (reflecting increasing detected pressure) to a maximum value of 1.

An example where the extent is the number of luminaires may in some cases be considered equivalent to the selective application of a binary weighting factor of 0 or 1.

In embodiments the user terminal may comprise a display, such as a touchscreen for example, on a smart device such as a smartphone, watch or tablet, and may provide a graphical user interface (GUI). However, it should be appreciated that a display is not necessary, and pressure of a user input can be detected by a user terminal which does not comprise any display. For example a pressure sensitive panel or switch, such as a wall panel, may be employed.

Where the user terminal does comprise a display, in embodiments the method may further comprise displaying on a display of said user terminal one or more graphical objects representing said one or more lighting devices. The display may be a touchscreen for example, on a smart device such as a smartphone or tablet, and may provide a graphical user interface (GUI). The position on the display of a user touch or pointer input relative to the position of one or more of said graphical objects may be used to provide lighting control, and therefore the position of the touch input may be detected in embodiments. The position may be a static position, or the position can be dynamic, representing movement of the touch input, for example a drag or swipe input.

The position of the graphical objects on the display may in examples be representative of the real spatial position of the lighting devices which they represent, or of the spatial position of the light output of such device(s). This may assist a user to visualize a lighting effect, and allows a user a more intuitive interface to control the lighting effect. Further objects representing the space may also be displayed for reference, such as walls, furniture or other features.

In embodiments, the position of the touch input may indicate the point of origin from which the extent of the lighting effect is measured. Additionally or alternatively, the distance from the graphical objects to position of the touch input may, in embodiments, be used in determining a weighting factor as discussed above.

By using position and pressure to control the effect, and in particular the extent or spread of the effect, multiple lighting parameters representing sophisticated effects can be simultaneously controlled in a simple and intuitive manner.

According to a further aspect of the invention there is provided a lighting control device for controlling a system of one or more lighting devices, said device comprising a user interface including a display, said user interface adapted to detect a touch input and to detect the pressure of said touch input; a processor adapted to associate a desired lighting effect with said touch input, and to determine an extent of said desired lighting effect based on said detected pressure; and a communication interface adapted to output control signals for said one or more lighting devices based on said desired lighting effect and the determined extent of said effect.

According to a yet further aspect of the invention, there is provided a computer implemented lighting control method comprising providing a GUI on a pressure sensitive display; receiving a touch input to said GUI and associating a desired lighting effect with said touch input, said lighting effect defined by a set of predetermined values for at least one lighting parameter for said one or more lighting devices; weighting said predetermined values based on the sensed pressure of said touch input, such that variations in sensed pressure alter the extent of said lighting effect; and outputting said weighted values to said one or more lighting devices.

In embodiments, weighting said predetermined values is based on the position of said touch on said GUI. In still further embodiments the method further comprises displaying on said GUI one or more graphical objects representing said one or more lighting devices, and wherein said weighting is based on the positions of said objects relative to the position of said touch on said GUI.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention extends to methods, apparatus and/or use substantially as herein described with reference to the accompanying drawings.

Any feature in one aspect of the invention may be applied to other aspects of the invention, in any appropriate combination. In particular, features of method aspects may be applied to apparatus aspects, and vice versa.

Furthermore, features implemented in hardware may generally be implemented in software, and vice versa. Any reference to software and hardware features herein should be construed accordingly.

### BRIEF DESCRIPTION OF THE DRAWINGS

Preferred features of the present invention will now be described, purely by way of example, with reference to the accompanying drawings, in which:

FIG. 1 shows an example of a lighting system installation;

FIG. 2 illustrates a lighting system schematically;

FIG. 3 illustrates data representing illumination setting for an example scene;

FIG. 4 shows a user interface device;

FIG. 5 illustrates an interface and a method of illumination control;

FIG. 6 is a graph showing brightness in response to pressure;

FIG. 7 is graph illustrating control of a weighting factor;

FIG. 8 illustrates a further example of an interface and a method of illumination control;

FIG. 9 is a flowchart illustrating a method of control;

FIG. 10 shows a processing architecture.

### DETAILED DESCRIPTION OF EMBODIMENTS

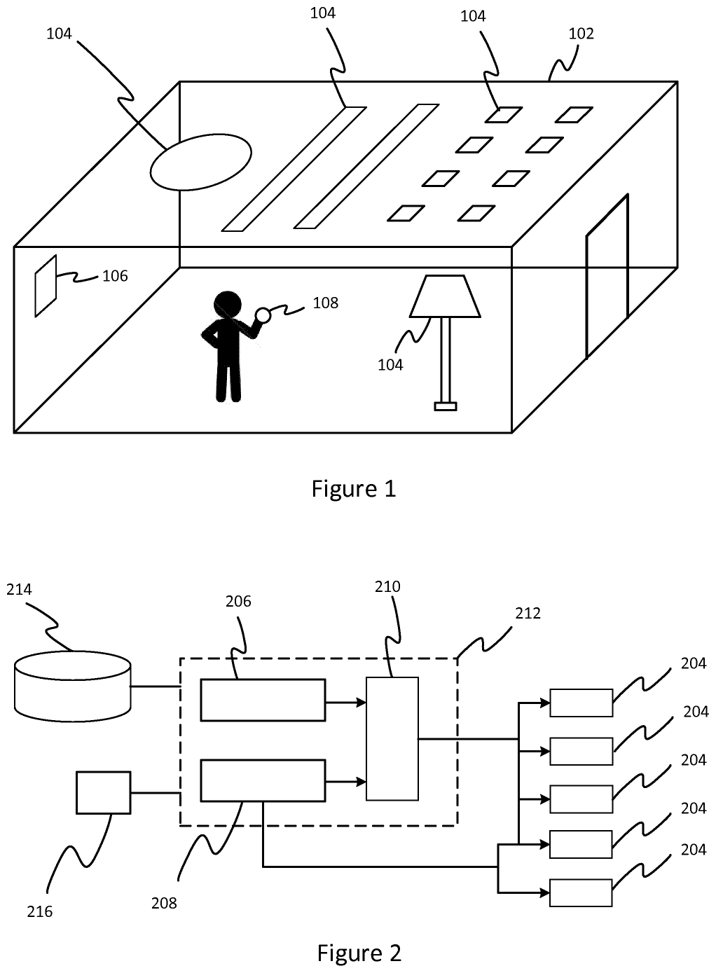

FIG. 1 shows a lighting system installed or otherwise disposed in an environment 102, e.g. an indoor space such as a room, or an outdoor space such as a garden or park, or a partially covered space such as a gazebo, or any other space that can be occupied by one or more people such as the interior of a vehicle. The lighting system comprises one or typically a plurality of lighting devices (or luminaires) 104, each comprising one or more lamps (illumination emitting elements) and associated housing, socket(s) and/or support, if any. LEDs may be used as illumination emitting elements, but other alternatives such as incandescent lamps e.g. halogen lamps. A luminaire 104 is a lighting device for emitting illumination on a scale suitable for illuminating an environment 102 occupiable by a user. For example, a luminaire 104 may be a ceiling mounted luminaire, such as a spotlight or wall washer, a wall mounted luminaire, or a free standing luminaire such as a floor lamp or desk lamp for example (and each need not necessarily be of the same type).

A user can control the lighting system via a user terminal such as a wall panel 106. Alternatively or additionally a mobile user terminal 108 may be provided in order to allow the user to control the lighting system. This will typically be in the form of a smartphone, watch or tablet for example, running an application or “app”. Either or both of the wall panel and the mobile user terminal may be pressure sensitive to detect applied pressure of an input. The user terminal or terminals may comprise a user interface such as a touchscreen or a point-and-click interface arranged to enable a user (e.g. a user present in the environment 102, or located remotely in the case of a mobile terminal) to provide user inputs to the lighting control application. A user may also be able to control individual luminaires, or a system of connected luminaires by interfacing directly with the luminaire e.g. in the case of a table lamp.

Referring to FIG. 2, an example of a lighting system is shown schematically. A user terminal 206, connects to luminaires 204 via an intermediate device 210 such as a wireless router, access point or lighting bridge. User terminal 206 could for example be the wall panel 106 of FIG. 1, and the intermediate device could be integrated in the wall panel or provided as a separate device. User terminal 208 is a mobile user terminal, such as terminal 108 of FIG. 1, and may also connect to the luminaires via the device 210, but may additionally or alternatively connect to the luminaires directly without an intermediate device. Connection between the devices may be wired, using a protocol such as DMX or Ethernet, or wireless using a networking protocol such as ZigBee, Wi-Fi or Bluetooth for example. Luminaires may be accessible only via device 210, only directly from a user terminal, or both.

For instance the user terminal 206 may connect to the intermediate device 210 via a first wireless access technology such as Wi-Fi, while the device 210 may connect onwards to the luminaires 204 via a second wireless access technology such as ZigBee. In this case intermediate device 210 converts the lighting control commands from one protocol to another.

Device 210 and user terminals 206 and 208 comprise a functional group illustrated schematically by dashed line and labelled 212. This functional group may further be connected to a storage device or server 214, which may be part of a network or the internet for example. Each element of the group 212 may include a memory, or have access to a storage function, which may be provided by storage device or server 214. Luminaires 204, or at least some of the luminaires 204, also include a memory.

This arrangement allows input of user commands at a user interface of a user terminal 206 or 208, and transmission of corresponding control signals to appropriate luminaires for changing illumination (e.g. recalling a specified scene).

Illumination settings can be created by a user by individually adjusting or programming parameter settings of luminaries. For example a user can manually adjust one or more luminaries in a room, via inputs at wall panel 106 perhaps, or via a mobile user terminal such as 208. Values of brightness and/or color can be altered, until the user is satisfied with the overall effect. The user can then input an instruction to a user terminal to store the current settings, and will typically assign a name or ID to the scene created. Illumination settings could also be obtained from an external source, such as the internet for example.

Illumination can also be controlled, or control can be augmented, by information gathered on environmental conditions in the vicinity of the system. Ambient light level for example can be used to automatically adjust the output of luminaires, or program certain settings. Time of day may also be used, as well as information on whether a person or persons are present, and possibly also the identity of that person(s), to control illumination output based on predetermined settings or values, or combinations of such settings or values. Such environmental conditions or information can be used by terminal 206 or 208, and/or device 210 to allow at least a degree of automation in controlling the output of luminaires 204. Automated control of settings can be augmented or overwritten by manual input if desired.

In embodiments, a sensor or sensor interface 216 provides information of sensed environmental information or inputs to one or more elements of the functional group 212. For example, sensors can include a light sensor, a PIR sensor, and/or an RFID sensor. A clock input for providing the current time of day can also be provided. Such sensors can be located in or around environment 102 of FIG. 1, and could be wall or ceiling mounted for example. In embodiments, sensors could be integrated into any or luminaires 104. Additionally or alternatively, terminals 206 or 208, or device 210 may include sensors to provide such information, particularly in the case of a mobile terminal in the form of a smartphone for example.

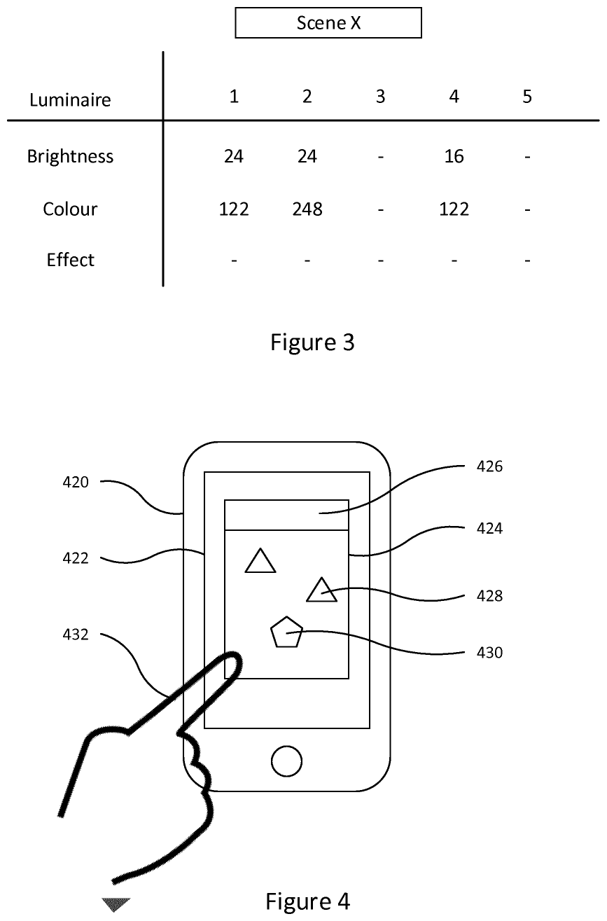

FIG. 3 illustrates data representing illumination settings for a given scene.

The data shows parameter values corresponding to different luminaries for a given scene. In this example, a lighting system includes five individually addressable luminaires, but the particular scene, say scene X, requires only three—numbers 1, 2 and 4. For each of these luminaires, a brightness value and a color value are provided. An effect value is an example of a possible further parameter which could be included, but which is not used in this example. Luminaires 3 and 5 are not used, and therefore parameter values are not included for these luminaires, for this scene.

Single numerical values of brightness and color are provided here as simplistic examples, but it will be understood that different embodiments may use different values or combinations of values to represent parameters. For example color could be represented by three values in RGB or L*a*b* color space.

In an example of a typical user operation for recalling a setting for use for example, the user may view a list of possible settings on a smartphone acting as a mobile user terminal 108. Using a touchscreen interface on the smartphone, the user can scroll and select a particular setting or scene identified by a name or ID, and apply the scene.

FIG. 4 illustrates a user interface of a mobile user terminal or device, such as terminal 208 for example. In this example the mobile device is a smartphone 420 and includes a screen or display 422, which displays a window 424 including a header bar 426 and graphical objects such as 428 and 430.

The screen or display is a touchscreen and is able to detect a touch of a user indicated by hand 432, however touch may be by any type of pointer such as a stylus for example. The touchscreen is able to detect user inputs such as a touch down or touch on, when a user first touches the screen, a move when the pointer is moved along the screen while maintaining contact with the screen, and a lift, or touch off, when a pointer ceases to be in contact with the screen.

In addition, a user interface such as touchscreen 422 is able to detect the pressure of a touch in examples. This effectively provides an added dimension to the user input. The detection of pressure may be a multivariable detection, providing a substantially continuous scale of detected pressures, or may be a discrete detection, attributing a range of pressures to a single value or input. In examples, a binary pressure detection provides only two values of pressure to be sensed—which may be considered a “light” press, and a “hard” press. Such binary values may be defined by a threshold pressure, with a “hard” press being defined as a touch having a pressure equal to or exceeding a threshold pressure. A calibration process may be used for a user to define thresholds or ranges of values attributed to detected pressure. In this way different pressures applied by different people can result in the same detected value, based on the respective calibration.

Window 424 is output by the execution of a program or application (“app”) running on the mobile device. A header bar 426 may be provided to identify the application which is running, and optionally provide controls relating to the application. Objects such as object 428 and 430 are provided in the main part of the window, and represent lighting devices or luminaires of a lighting or illumination system. Multiple different types of luminaires can be represented, and here two different types are indicated by different shapes of objects 428 and 430. A user is able to control the output of the lighting devices by providing inputs to the interface, in the form of touch operations on the touchscreen 422.

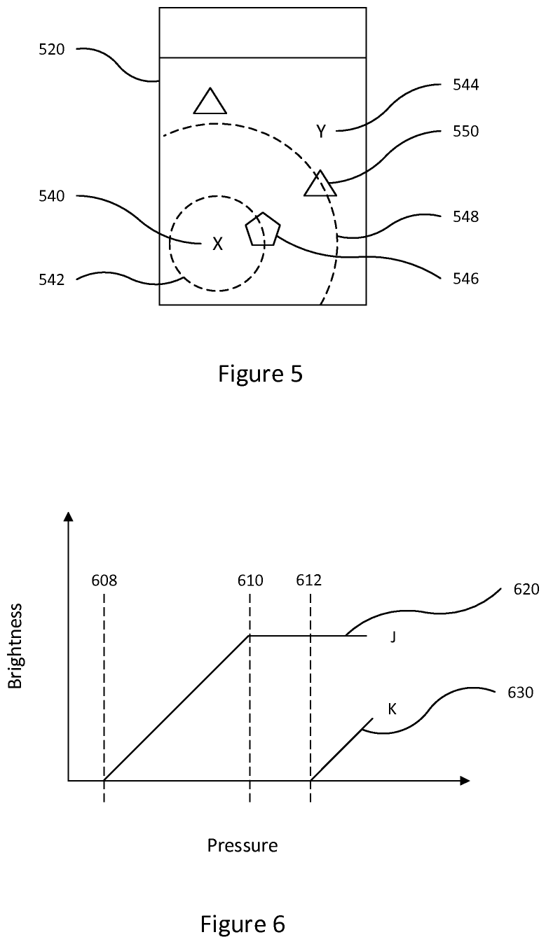

In the example of FIG. 4, a touch on the device 420, or the display 422 of the device indicates a parameter or set of parameters to be applied to lighting devices in the system. The parameter may be brightness or color for example, or may be a combination of such parameters. FIG. 5 illustrates how detected pressure of a touch on the display 422 is used to control the extent to which the parameter or parameters are applied to the lighting devices of the system.

Turning to FIG. 5, an example window 520 corresponding to window 420 of FIG. 4 is shown, and the position marked with an X 540 indicated the position of a touch, or touch down detected by the mobile user device. The action of touching down is associated with a parameter or set of parameters to control the output of the lighting devices, and determination or selection of these parameters may be by a previous user operation, such as a menu selection, or by any other appropriate means such as reverting to a default value for example.

The device detects the pressure of the touch, and this is indicated schematically by dashed rings 542 and 548. The size of the ring (i.e. the radius or diameter) reflects the pressure, with increasing size representing greater pressure.

Here rings are shown purely for illustrative purposes to show changes in pressure, however in examples feedback can be provided to a user to indicate the pressure or change of pressure being applied. Visual feedback is one possibility, and the rings illustrated are one example, however other visual devices or objects could be used to indicate pressure to a user, such as radiating lines or arrows, or a deformation effect mimicking a bending or flexing of the display. Feedback may also be provided via the objects representing lighting devices, indicating the light output of such devices in response to the user input pressure. Feedback of pressure could additionally or alternatively be non-visual, such as haptic or audio feedback.

Objects 546 and 550 represent lighting devices in the system, and are shown in positions at differing distances from the position of the touch 540. As will be explained in greater detail below, the positions of objects may represent the actual positions of the corresponding lighting devices in the real world, or may be set out in another arrangement, for ease of control by a user for example.

A touch with a small pressure is used to apply the determined or selected lighting parameters selectively to lighting devices represented on the display at a correspondingly small distance from the position of the touch. For example, at a pressure represented by ring 542, only the device represented by object 546 is controlled with the relevant parameters, and devices represented by objects at a greater distance are unaffected. As the pressure is increased however, devices represented as further from the touch point on the display are increasingly affected or controlled, and at a pressure corresponding to ring 548, the device corresponding to object 550 is also controlled with the relevant parameters.

FIG. 6 shows a graph illustrating more clearly the effect of the interface described above in relation to FIG. 5.

In the example of FIG. 6, a lighting parameter to be controlled is brightness, and a touch to a user interface is used to set a particular brightness value to a lighting system where the default or existing state of the devices is off, or zero brightness. Therefore in FIG. 6, brightness is plotted against pressure. A first plot, 620, represents the brightness of a device corresponding to object 546 of FIG. 5 (referred to as device J for simplicity), and a second plot, 630, represents the brightness of a device corresponding to object 550 of FIG. 5 (referred to as device K for simplicity).

Considering the touch applied to the interface at point 540 of FIG. 5, increasing pressure is shown moving along the horizontal axis of FIG. 6, and can be considered in this example as equivalent to increasing radius of the dashed rings shown in FIG. 5. When the pressure is increased to a value 608, device J is switched on, and as the pressure increases further, so the brightness of device J increases linearly to point 610. When the pressure reaches value 610, the brightness of device J is at the set level attributed to the touch. Further increasing the pressure of the touch does not change the brightness of device J which remains constant. However, when the applied pressure reaches value 612, device K is switched on, and further increasing the pressure linearly ramps up the brightness of device K in a similar manner.

Therefore, a single touch operation of a user can control the brightness of two devices J and K in two different ways, the difference being a reflection of the position of the touch point 540 in relation to the position of the objects 546 and 550 on the user interface. At each position of pressure, indicated by a vertical line on the graph of FIG. 6, two different values of brightness are assigned to the devices J and K (although it is possible that further increasing the pressure will result in both devices operating at the set level attributed to the touch).

The above describes the effect of pressure and brightness increasing, but control is also provided by decreasing the pressure of the touch in an equivalent fashion. In this case the vertical line indicating the current level of pressure can be considered to move to the left as viewed in FIG. 6, and the brightness of the respective devices is given by following the intersection on traces 620 and 630 from right to left.

It will be understood, that by changing the position of the touch point, the response of the lighting devices to increasing and decreasing pressure may vary. For example, by touching down initially at point Y, labelled 544 in FIG. 5, a light pressure touch will initially apply control to device K, and increasing pressure is required to extend control to device J.

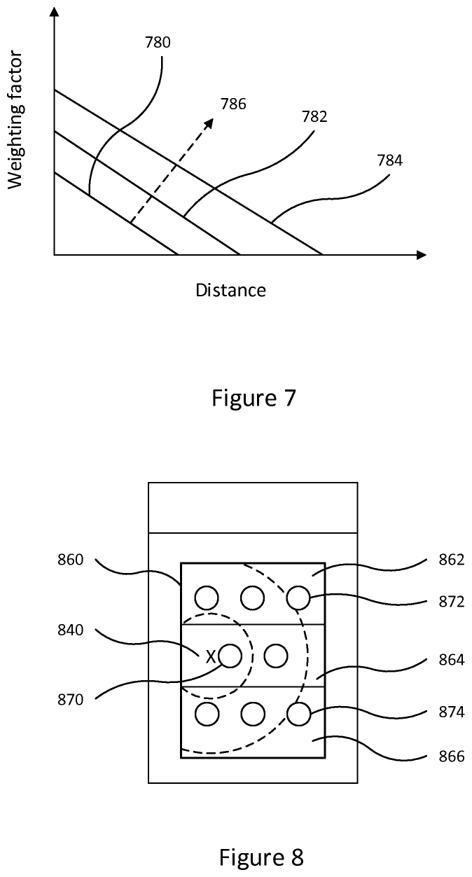

Therefore it will be understood that the effect or extent of control of the lighting device or devices of the system is a function of pressure applied and position of the corresponding object from the touch point on the user interface. This is illustrated in FIG. 7.

FIG. 7 is a graph plotting a control parameter against distance from a touch point on a user interface. The control parameter may be used to control the applied degree of a given lighting parameter or parameters, such as a weighting factor or multiplier for example, and can control the extent to which a given lighting effect is applied to a given lighting device. Three plots 780, 782, and 784 are shown, each representing the relationship between the control parameter and distance for a constant applied pressure. The different plots represent different pressures, with pressure increasing as illustrated by dashed arrow 786. It can be seen that for constant distance, increasing pressure results in an increase in the control parameter, and for constant pressure, increasing distance results in a decrease in the control parameter.

In this example, the plots are linear, but non-linear forms are equally possible, including exponential or quadratic relationships, and stepped, discrete or quasi discrete relationships. For example a control parameter may be compared to a threshold for a lighting device, and that device can be switched between two (or more) discrete states, depending on the result of the comparison. Thus the control parameter can, in some examples, act as an on/off switch for the application of a lighting effect. The threshold may be the same for all devices in a system, or may vary from device to device, or between groups of devices. In this way, the extent of the effect can be considered as the number of luminaires or lighting devices to receive that effect.

Equal pressure increments may result in uniformly distributed plots (equal spacing between plots, or a non-uniform relationship may be observed. Furthermore, the slope and/or shape of each plot may vary with changing pressure, i.e. the relationship between the control parameter and distance may vary with varying pressure.

The above description has assumed a stationary touch, however the touch position can be moved on the interface to dynamically change the control of the lighting devices of the system. This may take the form of a “swipe” or “drag” operation on a touchscreen. As the position of the touch moves, the relative distance to the various objects changes, and therefore so does the corresponding effect of control of the parameters. Corresponding changes to the extent of application of a lighting effect can be understood by considering a movement of a point horizontally (for constant pressure) across the graph of FIG. 7.

Therefore, control is afforded in three dimensions—with movement in the plane of the display device or touchscreen in two dimensions, and pressure in a third dimension, allowing multiple devices to be controlled easily and intuitively.

In the examples described above, the position of objects on a display may not correspond to the position of the corresponding luminaires of lighting devices in reality. The positions may instead be assigned to give greater control, for example to “group” devices together by providing their corresponding objects in the same place on the user interface. In one example, all objects can be collapsed to a single point, and the distance of the touch to an object can effectively be negated. In such an example, the control is one dimensional, with only variations in pressure affecting the lighting output. This might be used in a night mode for example, where a low pressure touch (irrespective of position on a screen or user interface) produces a low level illumination, and increasing pressure increases the level or brightness of illumination of one or a group of luminaires.

In a further example, control can again be made independent of the position of a touch, by effectively defining a default position. For example in a bedroom, the position of the bed, or one side of the bed may be defined as a default position in a night mode, and only the pressure of a touch input is determined, the position being automatically assigned to the default position. In such an example a light pressure touch may provide illumination near to the bed—a bedside lamp say—and increasing pressure spreads increasing brightness or illumination to increasing distance from the bed—to an opposite side bedside lamp, a ceiling light above the bed, and progressively to other rooms such as a hall light for example.

Further, by placing the objects in positions on the interface which do not correspond to their locations in space, more interesting and unexpected lighting patterns may result.

However, in some examples it may be beneficial for the objects on a user interface to be positioned to correspond to the actual positions of the luminaires to which they correspond.

FIG. 8 shows an example display of a user interface. A bounding rectangle 860 represents the walls of a room, and objects such as 870 and 872 representing luminaires are shown corresponding to the position of those luminaires in the room. A user touch is provided at position 840 illustrated with an X, and the touch is associated with lighting parameters to achieve a desired lighting effect.

In the above description, lighting parameters such as brightness or color have been provided as examples. However, further parameters, such as saturation, intensity, and temperature, and combinations of these parameters can be controlled in the manner described. In the above examples the parameters associated with a touch input have been uniform, such as a specific brightness or color, however as will be explained, an effect may be defined which has different parameters for different luminaires or lighting devices.

In the example of FIG. 8, as indicated by the horizontal lines, the room is divided into three sections, 862, 864 and 866 and the effect to be applied is for luminaires in each section to adopt a different color—for example, red white and blue to give the effect of a flag. Thus the effect can be considered as a ‘mask’ or ‘scene’ as described above. Therefore if the effect is applied to luminaire 872, it is controlled to provide a red illumination output, while if the same effect is applied to luminaire 874, it is controlled to provide a blue illumination output.

Considering a touch applied at position 840, with a low pressure applied this will apply the effect selectively to luminaire 870, with increasing pressure progressively applying the effect to luminaires further from the point 840, as shown by dashed rings of increasing radius.

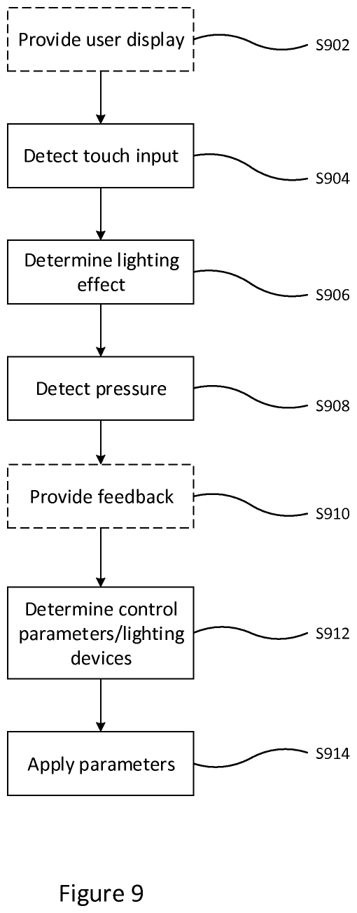

FIG. 9 is a flowchart illustrating a method of illumination control, including some of the steps outlined above.

In step S902 a touch input to a user terminal, such as a wall panel or a mobile device is detected. In step S904, a lighting effect is determined which is to be controlled by the touch input. This may be determined based on the detected input, based on a separate input or a previous input or inputs, or could be a default effect for example.

Thus it will be understood that a lighting scene or mask can be “spread” across a room or space in a controlled manner, from a selected position. As noted above the control can be to increase or decrease the spread by increasing or decreasing the pressure, and the “central” point or source of the spread can be selected or moved according to the position of the touch on the display or interface.

As well as static effects, both uniform and non-uniform, dynamic effects can be controlled. A dynamic effect may be flashing or pulsing for example, and any change in a lighting parameter or parameters over time.

FIG. 9 is a flowchart illustrating a method of illumination control, including some of the steps outlined above. In step S902 an initial step of providing a user display is optionally performed. A user display may not be possible or required however, or could already be available for example. The display will typically include display objects representing lighting devices of a lighting system as illustrated in FIGS. 5 and 8 for example.

At step S904, a touch input to a user terminal, such as a wall panel or a mobile device is detected. The user terminal will usually, but not always, include a touchscreen for providing a user interface. The detection of the touch input will typically detect the location or position of the touch on a user interface. In step S906, a lighting effect is determined which is to be controlled by the touch input. This may be determined based on the detected input, based on a separate input or a previous input or inputs to the system, optionally via a separate user terminal or user interface. Alternatively the effect may be determined by other inputs to the system such as sensor inputs or a time/date input, or may be a default effect.

At step S908, the pressure of the touch input is detected, for example using a pressure sensor or sensors in the user terminal. Optionally at step S910 feedback of the detected pressure is provided to the user, for example by visual, audio or haptic means.

At step S912, based on the determined lighting effect, and the detected touch input and associated pressure, control parameters and lighting devices to which those parameters should be applied are determined. In examples such as those described above, this determination is performed by considering parameters associated with the lighting effect, a point of origin for the effect and the extent of the effect. The extent may be represented by a control parameter, as illustrated in FIG. 7 for example.

Finally in step S914, the determined parameters are applied to the appropriate lighting device or devices, to provide the desired illumination corresponding to the input(s).

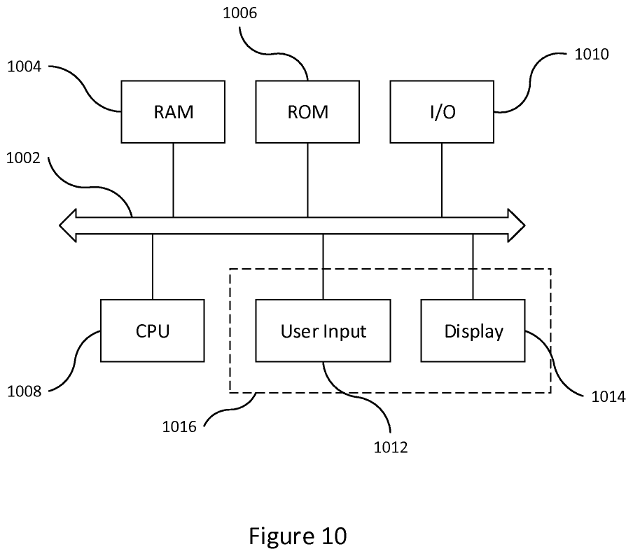

FIG. 10 shows a processing architecture capable of implementing a user terminal such as terminal 208 or mobile device 420 for example. A bus 1002 connects components including a ROM 1006, an RAM 1004 and a CPU 1008. The bus 1002 is also in communication with a communication interface 1010, which can provide outputs and receive inputs from an external network such as a lighting network or the internet for example. Also connected to the bus is a user input module 1012, which may comprise a pointing device such as a touchpad, which is adapted to detect the pressure of an input, for example using one or more pressure sensors. Also connected is a display 1014, such as an LCD or LED or OLED display panel. The display 1014 and input module 1012 can be integrated into a single device, such as a touchscreen, as indicated by dashed box 1016. Programs stored on the RAM or ROM for example can be executed by the CPU, to allow the user terminal to function as a user interface to control a lighting network which may be connected via communication interface 1010 for example. A user can interact with the user terminal, providing an input or inputs to module 1012, which may be in the form of tapping or swiping or otherwise interacting with the control device using a finger or other pointer on a touchscreen. Such inputs can be received and processed by the CPU, and an output provided, via network interface 1010, to a lighting system, which may be connected directly, or may be part of an external network. Visual information and feedback may also be provided to the user, by updating the display 1014, responsive to the user input(s).

It will be understood that the present invention has been described above purely by way of example, and modification of detail can be made within the scope of the invention. Each feature disclosed in the description, and (where appropriate) the claims and drawings may be provided independently or in any appropriate combination.

The various illustrative logical blocks, functional blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the function or functions described herein, optionally in combination with instructions stored in a memory or storage medium. A described processor, such as CPU 1008 may also be implemented as a combination of computing devices, e.g., a combination of a DSP and a microprocessor, or a plurality of microprocessors for example. Conversely, separately described functional blocks or modules may be integrated into a single processor. The steps of a method or algorithm described in connection with the present disclosure, such as the method illustrated by the flow diagram of FIG. 9, may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, and a CD-ROM.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored and/or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A lighting control method for controlling illumination of a space by a plurality of lighting devices with a user terminal, each lighting device being an individual luminaire, the method comprising:
detecting a touch input to said user terminal, and associating a desired lighting effect with said touch input;
detecting the pressure of said touch input, and determining an extent of said desired lighting effect based on said detected pressure; and
controlling said plurality of lighting devices based on said desired lighting effect and the determined extent of said desired lighting effect,
wherein the determined extent of said desired lighting effect based on said detected pressure is the number of lighting devices of the plurality of lighting devices controlled to produce said desired lighting effect.

2. A method according to claim 1, wherein detecting the pressure includes detecting changes in the pressure, and changing the extent of said desired lighting effect based on detected changes of the pressure.

3. A method according to claim 1, where the determined extent of said desired lighting effect is a measure of distance of said desired lighting effect from a point of origin in said space, wherein the desired lighting effect starts at said point of origin and extends or spreads through the space according to said measure of distance.

4. A method according to claim 1, wherein said desired lighting effect is defined by a set of predetermined values of at least one lighting parameter for said plurality of lighting devices.

5. A method according to claim 4, wherein said at least one parameter includes at least one of brightness, color, saturation, color temperature, or a parameter defining a dynamic effect.

6. A method according to claim 4, wherein controlling said plurality of lighting devices comprises determining parameter values based on said predetermined values, and a weighting factor based on the detected pressure of said touch input.

7. A method according to claim 1, further comprising displaying on a display of said user terminal one or more graphical objects representing said plurality of lighting devices.

8. A method according to claim 7, wherein detecting said touch includes determining the position of said touch on said display, and wherein said weighting factor is based on the distance of a graphical object representing a lighting device from the determined position of said touch, on said display.

9. A method according to claim 7, wherein detecting said touch includes determining the position of said touch on said display, and wherein said point of origin in said space is determined based on the detected position of said touch on said user interface.

10. A lighting control device for controlling a system of a plurality of lighting devices, each lighting device being an individual luminaire, said lighting control device comprising:
a user interface, said user interface adapted to detect a touch input and to detect the pressure of said touch input;
a processor adapted to associate a desired lighting effect with said touch input, and to determine an extent of said desired lighting effect based on said detected pressure; and
a communication interface adapted to output control signals for said plurality of lighting devices based on said desired lighting effect and the determined extent of said desired lighting effect,
wherein the determined extent of said desired lighting effect based on said detected pressure is the number of lighting devices of the plurality of lighting devices controlled to produce said desired lighting effect.

11. A lighting control device according to claim 10, wherein said processor is adapted to:
provide a GUI on said user interface;
obtain a set of predetermined values of at least one lighting parameter for said plurality of lighting devices, said predetermined values defining said desired lighting effect;
weight said predetermined values based on the detected pressure of said touch input, such that variations in detected pressure alter the extent of said desired lighting effect; and
output, via the communication interface, weighted values to said plurality of lighting devices.

12. A lighting control device according to claim 11, wherein said processor is adapted to perform said weighting based on the position of said touch on said GUI.

13. A lighting control device according to claim 11, wherein said processor is further adapted to display on said GUI one or more graphical objects representing said plurality of lighting devices, and wherein said weighting is performed based on the positions of said objects relative to the position of said touch on said GUI.

14. A computer program comprising instructions which, when executed on the lighting control device of claim 1.
